(19) United States
(12) Patent Application Publication
(10) Pub. No.: US 2005/0176573 A1
(43) Pub. Date: Aug. 11, 2005

(54) Nondestructive ion exchange in phosphate glasses

(76) Inventors: Frank Thoma, Ruesselsheim (DE); Sylvia Biedenbender, Bingen (DE); Joseph Hayden, Clarks Summit, PA (US); Sally Pucilowski, Luzerne, PA (US); Bianca Schreder, Frankfurt (DE); Ulrich Peuchert, Bodenheim (DE); Ruediger Sprengard, Mainz (DE); Martin Letz, Klein-Winternheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/020,575

(22) Filed: Dec. 27, 2004

Related U.S. Application Data
(63) Continuation of application No. 10/792,907, filed on Mar. 5, 2004, now abandoned.

(30) Foreign Application Priority Data
Mar. 5, 2003 (DE) 103 09 826.7

(51) Int. Cl. C03C 3/085

(52) U.S. Cl. 501/69; 385/14

(57) ABSTRACT

To provide an improved ion exchange process for the gentle treatment of phosphate-containing glass substrates in salt melts, the invention provides a process in which the source for the ions used is a salt melt 10 which contains silver ions, wherein the salt melt 10 contains ammonium ions. Furthermore, the invention provides a glass material (100) which comprises a phosphate-containing glass (1) and at least one region (210) which contains at least a first composition of ions and at least one region (220) which contains at least a second composition of ions, producible by the process according to the invention.

### DESCRIPTION

The invention relates to a process for exchanging ions in a phosphate-containing glass substrate, in which the source for the ions used is a salt melt which contains silver ions, in accordance with the preamble of claim 1. Furthermore, the invention relates to a glass material, comprising a phosphate-containing glass and at least one region which has a different ion composition than this glass, in accordance with claim 15.

Phosphate glasses are used, for example, in optical communication technology as laser amplifiers or in general terms of glasses with laser properties. The term “laser” relates to light amplification by stimulated emission of radiation. In a laser, an active material, for example a glass, is provided with an active atomic substance, such as for example neodymium, in a suitable way. This active material is introduced into a resonator.

Phosphate laser glasses offer particular advantages for use as laser-active material. They have a low threshold value for the laser effect. Moreover, phosphate glass compositions are commercially available as optical components for use in laser systems. However, the ion exchange in phosphate glasses is only possible under exceptional circumstances, on account of the poor chemical resistance of these types of glass.

The production of optical waveguides by thermal ion exchange is a tried-and-tested technique which has long been in widespread use. If a glass which contains ions of type 1 is immersed in a salt melt which contains ions of type 2, the two types of ions can be exchanged.

Since the refractive index of a dielectric material, such as for example glass, is dependent on the electronic polarizability per unit volume of the ions in the dielectric material, the refractive index can be adjusted by changing the ion concentration. To set the composition of a defined range in the glass, it is customary to employ the diffusion method of thermal ion exchange. In this context, the exchange of ions from the melt for sodium ions from the glass is a process which is frequently employed.

A process of this type is described, for example, in U.S. Pat. No. 3,880,630. Silicate glasses, borosilicate glasses or phosphate glasses can be used as glass substrates in this process. A salt bath which contains the ions to be exchanged is used. This salt bath consists of potassium nitrate, sodium nitrate and thallium nitrate. The glass substrate contains sodium and potassium ions. The substrate is immersed in the melt in order in particular for thallium ions to be exchanged for ions in the glass. The ion exchange is assisted by the application of an electric field, and the temperatures used in this process are around 350° C.

However, it has emerged in this process that in particular phosphate glasses are subject to considerable damage from chemical attack when treated in salt melts at such high temperatures. The glass becomes cloudy, meaning that it is no longer suitable for use for optical applications.

To allow the temperature of salt melts to be reduced, it is possible to alter the composition of the salt melt. For example, EP 0 380 468 describes a process for producing waveguides by means of ion exchange of silver ions in which these high temperatures can be lowered by the use of eutectic melts of ammonium nitrate and silver nitrate. The glass substrate used is a soda-lime silicate glass. The use of eutectic melt makes it possible to lower the temperature of the salt bath to below 210° C.

However, EP 0 380 468 does not disclose any specific temperatures. If it is considered that the melting point of silver nitrate is 212° C., a much more significant reduction in the melt temperature is to be expected through the use of a eutectic. Moreover, the composition of the salt melt is not disclosed.

Furthermore, depending on the chemical resistance of the glasses, the process leads to varying degrees of corrosion to the glass surface, through even to complete destruction in particular of phosphate glasses. This greatly restricts the possible uses of ion exchange from a salt melt for phosphate glasses.

However, in particular these phosphate glasses are of considerable importance for use as laser-active glass substrate for the optical industry. U.S. Pat. No. 5,334,559 describes a phosphate glass which has a particularly advantageous composition in terms of its laser properties.

In the field of the telecommunication industry, in particular a wavelength of 1.3 μm is of particular interest, since this is the wavelength region in which commercial transmission fibers have low optical losses and scarcely any optical dispersion. Therefore, most optical fiber communications systems currently operate in a region around 1.3 μm. Laser-active devices which function in this region are required firstly as laser sources and secondly as optical amplifiers.

U.S. Pat. No. 5,334,559 describes a phosphate glass composition which can be used in particular to form channel waveguides which are laser-active on three levels, one of these levels being the region around 1.3 μm. The two other levels are available for future applications in further wavelength regions. Therefore, a method which allows waveguide structures to be produced reliably with a very high level of geometric accuracy without the glass being damaged in any way is required in particular for a phosphate glass of this type.

However, in particular in this advantageous glass, the use of conventional salt melts for production of waveguides by ion exchange has proven extremely difficult on account of the problematic resistance to corrosion of this glass.

Therefore, it is an object of the invention to provide an improved process in particular to allow the abovementioned phosphate glasses to be used as part of an ion exchange process. In particular, it is a further object of the invention to provide an improved salt melt which allows ion exchange to take place without significant damage to the glass surface.

This object is achieved in a surprisingly simple way by a process having the features of claim 1. Moreover, claim 16 gives a glass material which can be produced using the process according to the invention.

Therefore, the solution of the invention for the first time proposes a process for exchanging ions in a phosphate-containing glass substrate, in which a salt melt which contains silver ions and simultaneously contains ammonium ions is used as source for the ions.

Although EP 0 380 468 has already used a salt melt which contains ammonium ions for ion exchange in soda-lime silicate glasses, hitherto only the aspect of a reduced temperature resulting from the use of a eutectic melt has played a significant role in the prior art. Moreover, it has not hitherto been known to use salt melts which contain ammonium ions for the treatment of phosphate glasses, in particular for laser-active phosphate glasses. However, the inventors have for the first time discovered that, amazingly, the ammonium ions offer the considerable advantage of protecting phosphate-containing glass substrates from corrosive attack.

If the glass is immersed in the salt melt, entropy effects cause a thermal exchange of ions between the salt melt and the glass substrate. The salt melt according to the invention in this case protects the surface of the glass substrate from damage, allowing the treatment of sensitive glasses.

The ion exchange from the salt melt with the phosphate-containing glass substrate produces regions with different ion compositions cᵢ, which differ in terms of their optical properties, in particular in terms of the refractive index, in this substrate. Therefore, the invention offers the option of producing optical structures in phosphate-containing glass substrates. The protection of the surface from corrosion during the ion exchange in this process means that the geometry of the glass substrate is not altered in any way, and consequently the invention can advantageously be used to produce high-precision optical components.

A mask can be applied to at least one side of the phosphate-containing glass substrate. The use of a masked substrate means that the ion exchange takes place only in the regions of the glass substrate which are not covered by the mask. This makes it possible to produce three-dimensional structures from regions of different ion compositions cᵢ. Since the process according to the invention protects the surface of the glass substrate from corrosion, it is in particular possible to produce improved optical structures with sharp boundaries and defined optical properties. For example, it is possible to produce waveguides and/or diffractive elements in phosphate glasses which it is impossible to produce with conventional salt melts, since the dimensions of the structures formed by the ion exchange fluctuate considerably as a result of the chemical attack of ordinary salt melts on the glass substrate.

For energy reasons, it is desirable for it to be possible for the ion exchange to be carried out at the lowest possible temperatures. At the same time, however, the diffusion and therefore the ion exchange rate and the depth of penetration into the glass substrate are promoted by increasing temperatures. Particularly with a view to achieving high aspect ratios, i.e. the maximum possible ratios of depth to width of the structures produced, it is recommended for a temperature-independent diffusion to be superimposed on the temperature-dependent thermal diffusion, in order to assist the ion exchange even at reduced temperatures. Therefore, according to the process of the invention, it is advantageously possible for a field-assisted diffusion to be superimposed on the purely thermal diffusion.

For this purpose, the invention first of all provides for at least one side of the phosphate-containing glass substrate, in particular the opposite side from the mask, to be joined to a first contact layer. This first contact layer can be used as an electrode. A second electrode preferably comprises the salt melt as source for the ions which are to be exchanged. For this purpose, a further electrode, preferably made of platinum or another highly chemically stable material, is immersed in the salt melt. The mask side of the glass substrate is placed onto the salt melt, in such a manner that there is no electrical connection between the first electrode, which is applied to the opposite side from the mask, and the salt melt, which functions as a second electrode.

This creates the conditions for the thermal diffusion to be assisted by the generation of an electric field by application of a voltage U between the first contact layer, on the opposite side from the mask, and the salt melt or the second electrode. In this way, the invention offers the advantage of being able to influence the ion exchange by various means.

Firstly, the field distribution in the interior of the phosphate-containing glass substrate can be configured in such a manner that the diffusing ions are diverted into predeterminable regions and/or are kept away from predeterminable regions. This allows defined three-dimensional structures to be produced by ion exchange in a targeted manner even in the interior of the glass substrate.

Secondly, the ion exchange itself can be assisted by the action of the electric field. In this case, with a predetermined concentration gradient the extent of diffusion can be increased significantly even at relatively low temperatures by virtue of an additional driving force for the diffusion being provided under the action of the electric field.

The invention therefore offers the advantage that particularly high aspect ratios of the structures produced by the ion exchange can be realized by superimposing the field-assisted ion exchange in the case of a phosphate-containing glass substrate.

The salt melt according to the invention comprises 1 mol % to 99 mol %, in particular 60 mol % to 80 mol %, in particular 75 mol %, of a silver-containing compound, in particular silver nitrate. It has been found that this quantity is already sufficient for ample ion exchange of the silver ions. It is therefore possible to add further compounds which lead to reduced corrosion of the substrate. According to the invention, the salt melt also contains 1 mol % to 99 mol %, in particular 20 mol % to 40 mol %, in particular 25 mol %, of an ammonium-containing compound, in particular ammonium nitrate. The addition of the ammonium ions considerably increases the protection against corrosion provided to the phosphate-containing glass substrate. In this way, the phosphate-containing glass substrate is advantageously protected from chemical attacks.

Since the invention uses the effect of the ammonium ions with regard to corrosion protection, which has been discovered for the first time, it is possible to maintain a variable composition of the salt melt. For example, in particular a change in the composition of the salt melt during the process, as a result of the exchange of ions from the salt melt for ions from the glass substrate, with an inevitable associated change in melting point of the salt melt, is of no importance to the process according to the invention.

In particular, it is not necessary to maintain a eutectic composition of, for example, ammonium nitrate and silver nitrate. In this case, the temperature range to be employed, on account of the melting point of silver nitrate lying at 212° C., would be established in the range below 212° C. However, with the composition of the salt melt in accordance with the invention, it is possible to reduce the temperature of the salt melt to below 190°. On account of this significantly reduced temperature, the process according to the invention not only offers advantages with regard to energy efficiency, but also assists with the gentle treatment of the substrate surface.

In the process according to the invention, the ion exchange can be influenced by at least the silver ion concentration and/or the ammonium ion concentration and/or the temperature and/or the voltage U and/or the ion current I and/or the residence time being set and/or regulated and/or controlled.

Therefore, a plurality of mutually independent process parameters are advantageously recommended for setting the configuration of the structures to be produced by ion exchange. For example, the production of structured regions can easily be matched to completely different requirements by suitably selecting the process parameters and the way in which they are adapted to one another.

If, for example, waveguides which are arranged in the interior of the phosphate-containing glass substrate are to be produced in the form of these structures, the invention provides for an ion exchange as described above to be carried out in one process step, and for the regions of the phosphate-containing glass substrate in which the ions have been exchanged to be transferred into the interior of the glass substrate under the action of an electric field in a subsequent process step.

The composition of the salt bath can be altered in such a way that the silver ions are replaced by the ions of the glass substrate for which they would normally be exchanged, for example by sodium.

As the process according to the invention continues, after the ion exchange has been carried out, the mask and/or the contact layer is removed from the phosphate-containing glass substrate. The result is then a starting material from which optical components, in particular diffractive optical elements and/or GRIN lenses, can be produced by further processing. Furthermore, the process according to the invention can be used to produce integrated optical components, in particular planar waveguides and/or splitters and/or combiners and/or planar amplifiers and/or optical chips and/or arranged waveguides (AWG) and/or frequency-selective elements, in particular Mach-Zehnder.

For completely different further processing options, the invention provides a glass material which includes a phosphate-containing glass and at least one region which contains at least a first composition of ions, and at least one further region, which contains at least a second composition of ions, which glass material can be produced using the process according to the invention.

The glass material according to the invention may in particular comprise a quantity of P₂O₅ in the range from 50 mol % to 70 mol % and a quantity of Al₂O₃ in the range from 4 mol % to 13 mol % and a quantity of Na₂O in the range from 10 mol % to 35 mol % and a quantity of La₂O₃ in the range from 0 mol % to 6 mol % and a quantity of Ln₂O₃ in the range from 0 mol % to 12 mol %, the quantity of Ln₂O₃ comprising, as Ln, Nd and/or Er and/or Yb,

and a quantity of R₂O in the range from 0 mol % to 18 mol %, the quantity of R₂O comprising, as R, Li and/or K and/or Rb and/or Cs,

and a quantity of MO in the range from 0 mol % to 20 mol %, the quantity of MO comprising, as M, Mg and/or Sr and/or Ca and/or Ba and/or Zn and/or Pb.

A glass material of this composition has been described in U.S. Pat. No. 5,334,559. The content of disclosure of this application is hereby incorporated by reference in its entirety in the subject matter of the present application.

The term Ln₂O₃ denotes the sum of the oxides of laser-active substances. These are usually selected from the lanthanides with atomic numbers of from 58 to 71.

However, it is also possible to use other laser-active substances or combinations of laser systems, in particular transition metals, such as for example chromium and vanadium. The invention for the first time offers the option of realizing regions of different ion compositions in the form of defined structures by ion exchange combined, at the same time, with protection against corrosion for the sensitive phosphate glass.

Al₂O₃ is added to the phosphate-containing glass mainly in order to increase its durability, since the phosphates are normally subject to considerable attack when treated in salt baths. Since the process according to the invention protects the phosphate glass from such attacks, it is for the first time possible to provide a glass material which has been structured by ion exchange and does not contain any Al₂O₃, but rather comprises a quantity of P₂O₅ in the range from 5 mol % to 65 mol %, and a quantity of Na₂O in the range from 15 mol % to 35 mol % and a quantity of WO₃ in the range from 30 mol % to 65 mol % and a quantity of Ln₂O₃, the quantity of Ln₂O₃ comprising, as Ln, La and/or Nd and/or Er and/or Yb, and a quantity of R₂O in the range from 0 mol % to 18 mol %, with the quantity of R₂O comprising, as R, Li and/or K and/or Rb and/or Cs, and a quantity of MO in the range from 0 mol % to 20 mol %, with the MO comprising, as M, Mg and/or Sr and/or Ca and/or Ba and/or Zn and/or Pb.

A further advantageous composition of the phosphate-containing glass in the glass material according to the invention comprises a quantity of P₂O₅ in the range from 50 mol % to 75 mol % and a quantity of Al₂O₃ in the range from 3 mol % to 15 mol % and a quantity of Ln₂O₃, the quantity of Ln₂O₃ comprising, as Ln, La and/or Nd and/or Er and/or Er and/or Yb, and a quantity of R₂O in the range from 0 mol % to 18 mol %, the quantity of R₂O comprising, as R, Li and/or Na and/or K and/or Rb and/or Cs, and a quantity of MO in the range from 0 mol % to 35 mol %, the quantity of MO comprising, as M, Mg and/or Sr and/or Ca and/or Ba and/or Zn and/or Pb.

Moreover, in this composition oxygen can be replaced by fluorine. The at least partial exchange of oxygen for fluorine means that the invention offers the advantage that the refractive index of the glass can be deliberately lowered. This results in the option of matching the glass to various requirements.

Moreover, the at least partial exchange of oxygen for fluorine makes it possible to counteract the reduction of silver ions in the glass to form atomic silver. Undesired reduction of the silver ions of this nature can be promoted in particular by frequently used additives, such as for example arsenic or antimony. A reduction of this nature leads to the formation of colloids, which cause coloration of the glass and, in addition to the associated undesirable optical impression, in particular increased attenuation in the glass. The exchange of oxygen for fluorine allows the invention to advantageously offer a simple way of introducing fluorine into the glass with an otherwise unchanged composition of the glass.

The invention is explained in more detail below on the basis of exemplary embodiments and with reference to the appended figures. Identical components are denoted by identical reference numerals throughout all the figures. In the drawing:

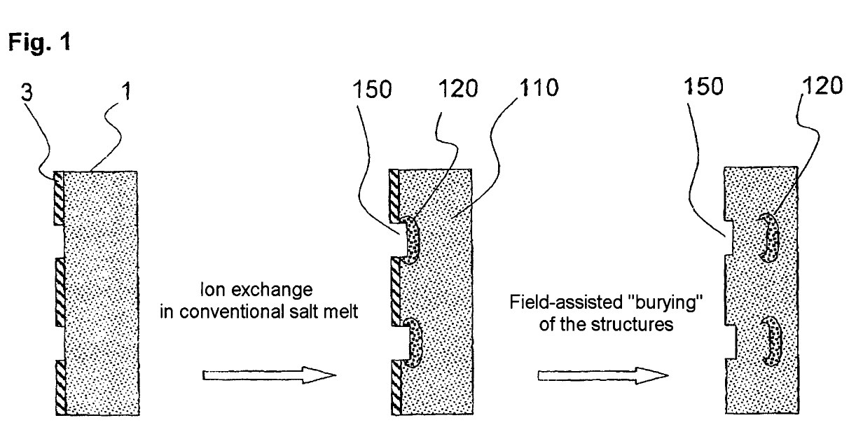

FIG. 1 diagrammatically depicts the change in the structure of a phosphate-containing glass substrate resulting from ion exchange in a conventional salt melt with subsequent field-assisted “burying” of the structures produced,

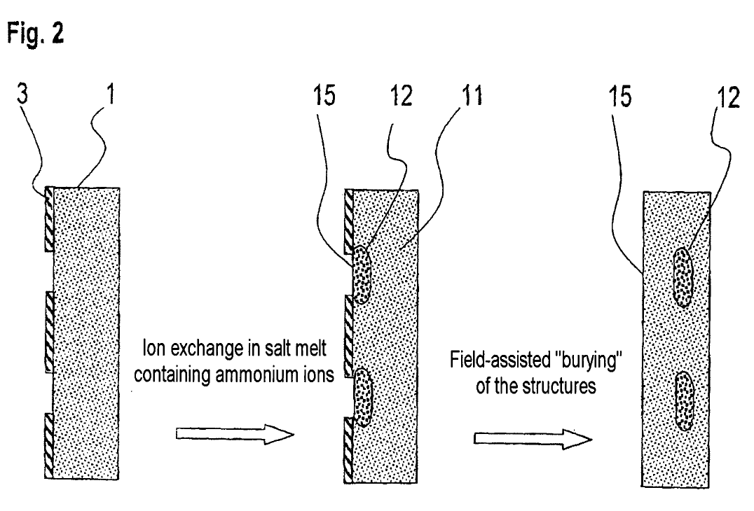

FIG. 2 diagrammatically depicts the production of buried structures by ion exchange in a salt melt according to the invention containing ammonium ions with subsequent field-assisted burying of the structures,

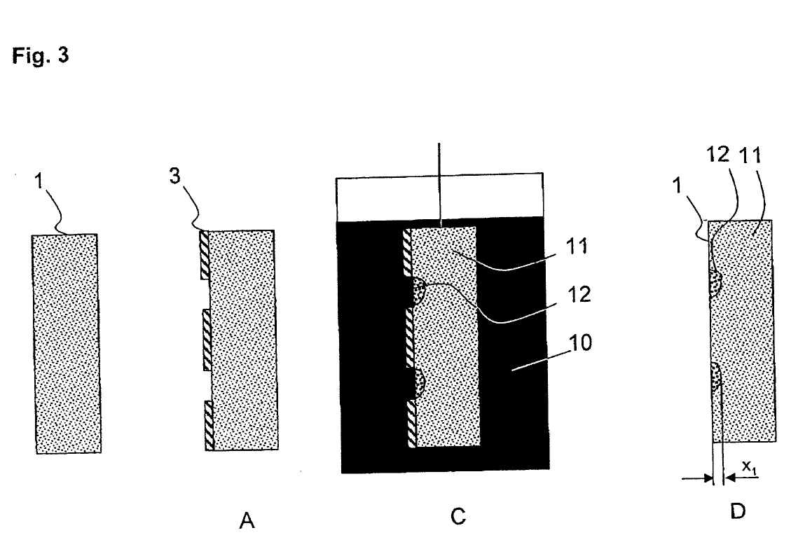

FIG. 3 diagrammatically depicts the process according to the invention in individual process steps in accordance with a first embodiment,

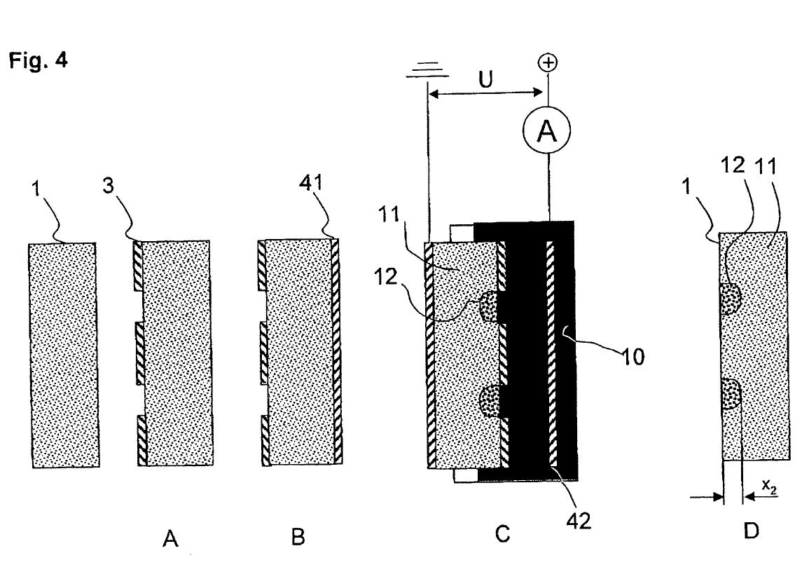

FIG. 4 diagrammatically depicts the process according to the invention in accordance with a second embodiment,

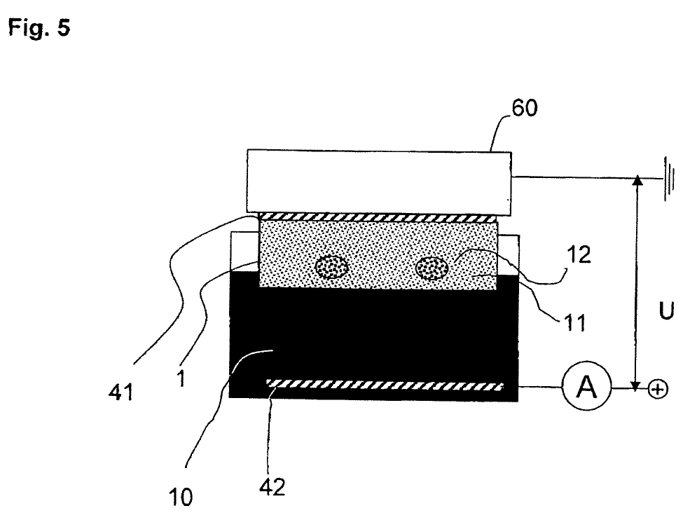

FIG. 5 diagrammatically depicts an arrangement for the field-assisted burying of structures produced by ion exchange,

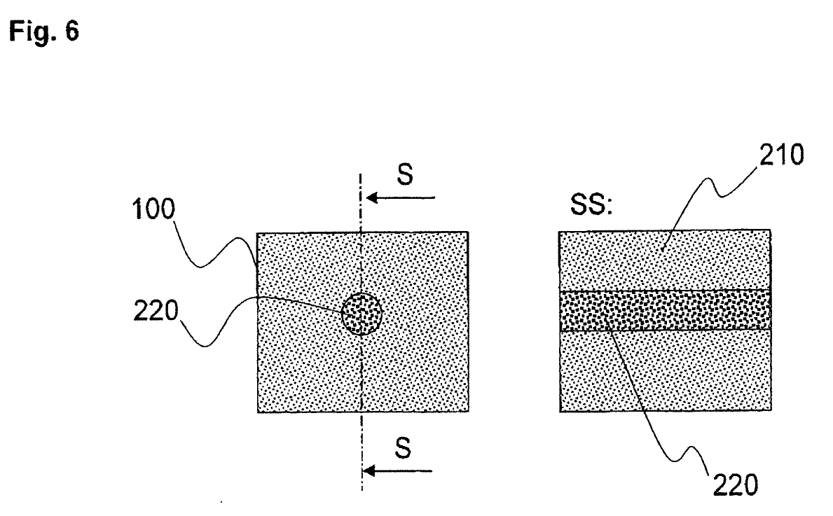

FIG. 6 shows a front view and sectional view on line S-S of a glass material according to the invention.

If, as is illustrated in FIG. 1, a phosphate-containing glass substrate 1 which is provided with a mask 3 is subjected to ion exchange in a salt melt of conventional composition, the phosphate-containing glass substrate 1 is damaged by chemical attack at the unmasked regions, in such a manner that recesses 150 are formed at these locations. At the same time, the composition of the glass substrate is altered by diffusion and ion exchange in the glass substrate, in such a manner that regions 120 whose composition differs from that of the original glass substrate 110 are formed. These regions 120 adjoin the recesses 150 and consequently have a sickle-shaped profile in longitudinal section. Under the action of an electric field, the structures 120 can migrate into the interior of the phosphate-containing glass substrate 1.

In the illustration on the right-hand side of FIG. 1, which illustrates the end product produced by the conventional process, the recesses 150 are still clearly apparent, as are the sickle-shaped structures 120. An optical component with damage of this nature at its surface and with undefined dimensions of the structures 120 of this nature does not in any way comply with the current requirements imposed on the quality of optical components.

However, the quality of a structured phosphate-containing glass substrate of this type can be considerably improved by means of the salt melt according to the invention which contains ammonium ions. If, as illustrated in FIG. 2, a phosphate containing glass substrate 1 with a mask 3 is subjected to ion exchange in a salt melt containing ammonium ions, its surface is protected from chemical attack, and consequently the surface 15 is not subject to any corrosion even in the unmasked regions. This is illustrated in the middle figure in FIG. 2. The ion exchange produces regions in the phosphate-containing glass substrate 1 which differ in terms of their ion composition from the original composition in the regions 11 of the phosphate-containing glass substrate 1. These structures 12 can be made to migrate into the interior of the glass substrate with the aid of an electric field.

The result of a field-assisted “burying” of the structures of this nature is shown in the right-hand image in FIG. 2. Compared to the corresponding image presented in FIG. 1, the significantly improved quality of the glass material is clearly visible. The process according to the invention leads to the surface 15 of the substrate being completely free of recesses 150 caused by corrosion. Furthermore, the structures 12 produced with the aid of the mask have a structure which is symmetrical in cross section and does not have any irregular formations like the regions 120.

FIG. 3 diagrammatically depicts the inventive sequence of the process in accordance with a first embodiment. In a first process step A, a mask 3 is applied to the phosphate-containing glass substrate 1. In the next process step C, the masked phosphate-containing glass substrate is immersed in a salt bath 10. Thermal diffusion produces regions 12 whose ion composition differs from that of the regions with the original ion composition 11 of the phosphate-containing glass substrate 1. After removal of the salt bath and the mask, the result, in process step D, is a phosphate-containing glass substrate 1 which has been structured by the regions 12, 11.

In accordance with second embodiment of the process according to the invention, the thermal diffusion can be assisted by the application of an electric field. FIG. 4 diagrammatically depicts this process in accordance with the second embodiment. In an additional process step E, the phosphate-containing glass substrate 1 which has been provided with a mask 3 is provided with a first contact layer 41. In a process step C, the glass substrate which has been prepared in this way is placed onto a salt melt 10. A voltage U is applied between the first contact layer 41 and a second electrode 42 which is sunk in the melt. As shown in the illustration corresponding to process step C in FIG. 4, the ion current I can be measured with the aid of an ammeter.

After the salt bath, the mask and the contact layer have been removed, the result, in process step D, is a structured phosphate-containing glass substrate having structures 12 and an untreated region 11.

Compared to the result of the process without field-assisted diffusion illustrated in FIG. 3, the field-assisted diffusion is able to produce structures 12 which have a considerably greater depth x₂ than the depth x₁ of the structures which have been produced by purely thermal diffusion, as shown in FIG. 3.

In accordance with a third embodiment of the invention, the structures 12 which have been produced by ion exchange in the regions of the phosphate-containing substrate 1 whose surface was not covered by the mask can be transferred into the interior of the glass substrate 1 by treatment with an electric field.

FIG. 5 shows a substrate holder 60 to which the phosphate-containing glass substrate 1 is fitted. The phosphate-containing glass substrate 1 is provided with a first contact layer 41. The mask 3 has already been removed. The glass substrate is placed onto the salt melt. A voltage U is applied between the contact layer 41 and a second electrode 42 which is sunk in the salt melt. Under the action of the voltage U, the regions 12 in which the ions of unchanged glass structure have been exchanged for ions from the glass melt 10 migrate into the interior of the glass substrate. In this way, it is possible to produce structures which have been shaped in any desired way, and have been arranged in three dimensions with respect to one another, in the phosphate-containing glass substrate.

FIG. 6 illustrates the result of this procedure. The glass material 100 comprises a region 220 which is not in contact with a surface of the glass substrate 100, but rather is arranged in the interior of the substrate. In particular the sectional view S-S on the right-hand side illustrates only the most simple way of implementing the process according to the invention for producing a glass material of this type with structures recessed in its interior. According to the invention, the region 220 can be arranged in any desired way in the interior of a glass substrate. In particular, it may comprise a plurality of structures which are connected to one another or may also be separate inside the glass substrate. They are surrounded by regions 210 whose composition has not been changed by ion exchange.

Moreover, the invention encompasses a combination of regions 220 in which the ions which were originally present in the glass substrate have been exchanged for different ions from salt baths, so that the regions 220 which are formed differ in terms of their properties not only from those of the original glass substrate 210 but also from one another. This can be realized in particular by the processes shown in FIGS. 3 and 4 being carried out with the steps A to D being passed through a number of times; in the process, it is possible to use different masks and/or different salt melts.

1. A process for exchanging ions in a phosphate-containing glass substrate 1, in which the source used for the ions is a salt melt 10 which contains silver ions, wherein the salt melt 10 contains ammonium ions.

2. The process as claimed in claim 1, wherein regions (11, 12) with different ion compositions cᵢ which differ in terms of their optical properties, in particular in terms of their refractive index, are produced by ion exchange in the phosphate-containing glass substrate 1.

3. The process as claimed in claim 1 or 2, wherein a mask (3) is applied to at least one side of the phosphate-containing glass substrate (1).

4. The process as claimed in claim 1 wherein at least one side of the phosphate-containing glass substrate (1), in particular the opposite side from the mask (3), is joined to a first contact layer (41).

5. The process as claimed in claim 4, wherein an electric field is generated in the phosphate-containing glass substrate (1) by the application of a voltage (U) between the first contact layer (41) and a second electrode (42), which is immersed in the salt melt.

6. The process as claimed in claim 5, wherein the ion exchange is assisted by the action of the electric field.

7. The process as claimed in claim 1 wherein the salt melt (10) contains from 1 mol % to 99 mol %, in particular 60 mol % to 80 mol %, in particular 75 mol %, of a silver-containing compound, in particular silver nitrate.

8. The process as claimed in claim 1 wherein the salt melt (10) comprises from 1 mol % to 99 mol %, in particular 20 mol % to 40 mol %, in particular 25 mol %, of an ammonium-containing compound, in particular ammonium nitrate.

9. The process as claimed in claim 1 wherein the temperature of the salt melt (10) is less than 190° C.

10. The process as claimed in claim 1 wherein the ion exchange is influenced by at least the silver ion concentration and/or the ammonium ion concentration and/or the temperature and/or the voltage U and/or the ion current and/or the residence time being set and/or regulated and/or controlled.

11. The process as claimed in claim 5, wherein, under the action of the electric field, the regions (12) of the phosphate-containing glass substrate (1) in which ions have been exchanged migrate into the interior of the glass substrate (1).

12. The process as claimed in claim 4, wherein the mask (3) and/or the contact layer (41, 42) are removed from the phosphate-containing glass substrate (1).

13. An optical component, in particular a diffractive optical element and/or GRIN lens, produced using the process as claimed in claim 1.

14. An integrated optical component, in particular a planar waveguide and/or splitter and/or combiner and/or planar amplifier and/or optical chip and/or arranged waveguide (AWG) and/or frequency-selective elements, in particular Mach-Zehnder, produced using the process as claimed in claim 1.

15. glass material (100), comprising a phosphate-containing glass (1) and at least one region (210) which contains at least a first composition of ions and at least one region (220) which contains at least a second composition of ions, producible by the process as claimed in claim 1.

16. The glass material (100) as claimed in claim 15, wherein the phosphate-containing glass (1) comprises
a quantity of P₂O₅ in the range from 50 mol % to 70 mol %, and
a quantity of Al₂O₃ in the range from 4 mol % to 13 mol %, and
a quantity of Na₂O in the range from 10 mol % to 35 mol %, and
a quantity of La₂O₃ in the range from 0 to 6 mol %, and
a quantity of Ln₂O₃ in the range from 0 to 12 mol %, the quantity of Ln₂O₃ comprising, as Ln, Nd and/or Er and/or Yb, and
a quantity of R₂O in the range from 0 to 18 mol %,
the quantity of R₂O comprising, as R, Li and/or K and/or Rb and/or Cs, and
a quantity of MO in the range from 0 to 20 mol %,
the quantity of MO comprising, as M, Mg and/or Sr and/or Ca an/or Ba and/or Zn and/or Pb.

17. The glass material (100) as claimed in claim 15, wherein the phosphate-containing glass (1) comprises
a quantity of P₂O₅ in the range from 5 mol % to 65 mol %, and
a quantity of Na₂O in the range from 15 mol % to 35 mol %, and
a quantity of WO₃ in the range from 30 mol % to 65 mol %, and
a quantity of Ln₂O₃, the quantity of Ln₂O₃ comprising, as Ln, La and/or Nd and/or Er and/or Yb, and
a quantity of R₂O in the range from 0 to 18 mol %,
the quantity of R₂O comprising, as R, Li and/or K and/or Rb and/or Cs, and
a quantity of MO in the range from 0 to 20 mol %,
the quantity of MO comprising, as M, Mg and/or Sr and/or Ca and/or Ba and/or Zn and/or Pb.

18. The glass material (100) as claimed in claim 15, wherein the phosphate-containing glass (1) comprises
a quantity of P₂O₅ in the range from 50 mol % to 75 mol %, and
a quantity of Al₂O₃ in the range from 3 mol % to 15 mol %, and
a quantity of Ln₂O₃,
the quantity of Ln₂O₃ comprising, as Ln, La and/or Nd and/or Er and/or Yb, and
a quantity of R₂O in the range from 0 to 18 mol %,
the quantity of R₂O comprising, as R, Li and/or Na and/or K and/or Rb and/or Cs, and
a quantity of MO in the range from 0 to 35 mol %,
the quantity of MO comprising, as M, Mg and/or Sr and/or Ca and/or Ba and/or Zn and/or Pb.

19. The glass material (100) as claimed in claim 18, wherein oxygen is replaced by fluorine.
